(19) United States
(12) Patent Application Publication
(10) Pub. No.: US 2016/0110980 A1
(43) Pub. Date: Apr. 21, 2016

(54) MULTI-CONDITION SENSING DEVICE INCLUDING AN IR SENSOR

(71) Applicants: Anant Aggarwal, Waltham, MA (US); Christian Breuer, Newburyport, MA (US); Christopher Fowles, Berwick, ME (US)

(72) Inventors: Anant Aggarwal, Waltham, MA (US); Christian Breuer, Newburyport, MA (US); Christopher Fowles, Berwick, ME (US)

(73) Assignee: OSRAM SYLVANIA INC., Danvers, MA (US)

(21) Appl. No.: 14/519,805

(22) Filed: Oct. 21, 2014

(51) Int. Cl. G08B 17/12; G01J 5/10

(52) U.S. Cl. CPC G08B 17/12; G01J 5/10; G01J 2005/106

(57) ABSTRACT

Techniques are disclosed for using an infrared (IR) sensor to sense flame and/or activity within an environment of a building, such as a home or office. One example embodiment provides a multi-condition sensing device that includes an IR sensor for sensing both human occupancy and fire within a given environment. Another example embodiment provides a multi-condition sensing device that includes a plurality of sensors. A first of the sensors includes an IR sensor that is adapted to sense IR radiation within a given environment. A second of the sensors is adapted to sense a second environmental condition (different than IR radiation) within the given environment. Another example embodiment provides a standalone modular sensor block with a standard communication interface to a building management system. The sensor block may act as a combo-sensor as well as an active fire detector and alarm.

### FIELD OF THE DISCLOSURE

This disclosure relates to a device for sensing multiple environmental conditions and more specifically to sensing the presence of unwanted fire, among other environmental conditions, with a device that includes an infrared (IR) sensor.

### BACKGROUND

Buildings may be outfitted with numerous types of environmental sensors and actuators that are operatively connected to a building management system. The building management system monitors environmental conditions through the sensors and controls aspects of the environment through the actuators. The building management system may also alert building occupants and/or a building manager when particular environmental conditions are detected, such as conditions suggestive of an unwanted fire. Examples of sensors include smoke detectors, carbon dioxide sensors, carbon monoxide sensors, occupancy sensors, relative humidity sensors, temperature sensors, and brightness sensors. Automated buildings not only include numerous types of sensors and actuators, but often numerous zones in which each type of sensor and actuator may be installed. The individual sensors and actuators are installed at different positions within an environmental zone. To this end, different types of sensors and actuators utilize different communication paths and standards.

### BRIEF DESCRIPTION OF THE DRAWINGS

FIG. 1 shows a device having a housing in which a processor, a communication interface, and multiple sensors may be mounted, including an IR sensor, according to one embodiment.

FIG. 2 shows a modular sensor housing that includes multiple housing segments, according to one embodiment.

FIG. 3 shows a housing segment of a modular sensor that that includes a luminaire, according to one embodiment.

FIG. 4 shows one example of an IR signature as sensed by an IR sensor having a 5×5 array of pixels, according to one embodiment.

### DETAILED DESCRIPTION

Techniques are disclosed for using an infrared (IR) sensor to sense flame and/or activity within an environment of a building, such as a home or office. One example embodiment provides a multi-condition sensing device that includes an IR sensor for sensing both human occupancy and fire within a given environment. Another example embodiment provides a multi-condition sensing device that includes a plurality of sensors. A first of the sensors includes an IR sensor that is adapted to sense IR radiation within a given environment. A second of the sensors is adapted to sense a second environmental condition (different than IR radiation, such as sound waves or humidity) within the given environment. In one example such configuration, the plurality of sensors are mounted or otherwise provided in the housing of a lighting fixture. In any such embodiments, the multi-condition sensing device may further include or otherwise be configured to communicatively couple with an image analysis processor that is programmed or otherwise configured to analyze image data provided by the IR sensor to determine statuses of the environment with respect to, for instance, human occupancy and/or fire. In some cases, the device includes a transmitter for transmitting IR sensor data to a remote entity where the image analysis can be carried out. A building management system communication interface may be used to facilitate communication between a building management system and the sensor(s). Numerous other embodiments and configurations will be apparent in light of this disclosure.

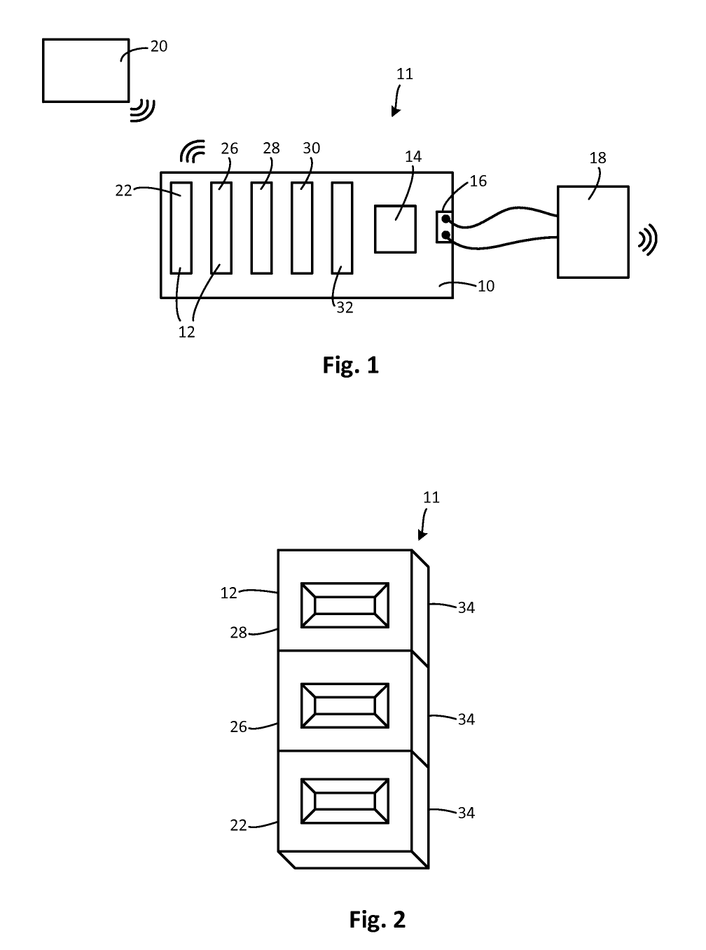

Turn now to FIG. 1, which shows an overall view of a system for monitoring multiple environmental conditions, according to one embodiment. A device 11 of the system includes a sensor housing 10 that has multiple sensor mounts 12 that may receive sensors of various types. A processor 14, also within the housing, receives and processes signals from the sensors. A communication interface 16 effectively provides a connection point between the processor 14 and a building management system 18 via which data and/or instructions may be shared. Communications may also be established through a user interface 20 of the device 11, as can be further seen with respect to FIG. 1.

The IR sensor 22 of the device 11 detects IR signatures within the environment. As will be appreciated, the sensor 22 may be implemented with an array of IR sensors. IR arrays generally include multiple, independent, infrared sensors or “pixels” that each receive infrared radiation, indicative of temperature, from a corresponding field of view within the environment. The field viewed by each pixel of an IR array may be determined by the positioning of the pixels within the array, one or more lenses that direct radiation to the pixels, and the like. The amount of radiation received by each pixel in an array may be viewed, collectively, to construct a view of the IR radiation emanating from the overall field of view within the environment. It is from such a view that an overall temperature map of the environment may be constructed and from which the device may detect various environmental conditions, such as unwanted fire.

IR arrays may be constructed in different manners. Individual pixels of an IR array are constructed of materials that generate energy when exposed to heat or IR radiation, such as gallium nitride, caesium nitrate, and polyvinyl fluorides, although other materials may also be used. Low resolution IR arrays, as used according to some embodiments, often include fewer than about 1000 pixels arranged in a grid. Other numbers of pixels and arrangements are possible and are contemplated, such as IR arrays that include pixels arranged in irregular patterns and that include more than 1000 pixels.

As will be appreciated in light of this disclosure, housing 10 may include mounts 12 for sensors other than the IR sensor 22. As illustrated in the embodiment of FIG. 1, the housing 10 includes a temperature sensor 26, a humidity sensor 28, a brightness sensor 30 and a color sensor 32 in addition to the IR sensor 22. Other types of sensors that may be mounted to the housing include, but are not limited to smoke detectors, carbon dioxide sensors, and carbon monoxide sensors, to name a few. Although a total of five mounts are shown, housings may be constructed with any number of sensor mounts, positioned within the housing in a variety of ways. It is to be appreciated that a sensor may be considered mounted to the housing when the sensor is physically supported by the housing, even if indirectly through another component, such as a processor board, bracket, or the like.

The processor 14 may be incorporated into the device 11 to process signals received from sensors and/or to drive operation of the sensors. The processor 14, according to some embodiments, may also be mounted to the housing 10 of the device. In other embodiments, the processor 14 may be located external or otherwise remote to the housing 10, and communicatively coupled to the various sensors via a wired or wireless communication link. In such cases, the housing 10 may further include a communication chip or transmitter for providing sensor data to the remote processor 14. In the example embodiment of FIG. 1, the processor 14 includes a microcontroller or an application specific integrated circuit (ASIC) that is capable of receiving and processing signals from each sensor. In other embodiments, the sensors may include or otherwise be associated with individual plug-and-play daughter cards that include drivers, processors, and other components for operating a particular sensor. The cards may be received by a mother board having one or more slots that are capable of accepting daughter cards for different types of sensors. In any such cases, the processor 14 can be programmed or otherwise configured to make determinations based on the sensor data it receives. For instance, in one embodiment, the processor 14 can determine if the target environment is occupied by a human and can also determine if an unwanted fire is present in the environment. In one such case, these two determinations are based on data from two distinct sensors, a fire sensor and an occupancy sensor. In another embodiment, these two determinations are based on data from the same sensor, and in particular, an IR sensor. Other device configurations are also possible as will be appreciated in light of this disclosure, including those that lack a processor.

FIG. 2 shows a modular sensor housing 10 that includes multiple housing segments 34, each having one or more sensor mounts 12. The housing segments 34 may be joined together, as desired, to provide an overall housing with a desired number of sensor mounts. In this respect, the number of sensor mounts provided by a housing, and the corresponding number and type of sensors, may be tailored as desired for a particular building environment. By way of example, the embodiment of FIG. 2 includes a housing segment in which an IR array is mounted. Two individual housing segments, one having a temperature sensor and one having a humidity sensor, are connected to the housing segment having the IR array. This results in a device with three different sensor types—an IR array 22, a temperature sensor 26, and a humidity sensor 28. It is to be appreciated that other combinations are also possible, including combinations that have different numbers of sensors and/or different types of sensors. In addition, other embodiments have a single sensor that carries out multiple condition detections, such as an IR sensor 22 that generates detections signals that can be used to detect both occupancy and fire, based on the analysis carried out by processor 14.

The housing segments of the embodiment shown in FIG. 2 include features that help to align and/or secure the housing segments to one another. By way of example, each segment may include a portion a dovetail joint (not shown). Other embodiments may include different alignment/engagement features, such as shoulders that abut one another to hold the segments in alignment while secured to one another with adhesives, fasteners, and the like.

Housings and/or housing segments may include breakaway tabs to promote modularity. By way of example, sensor mounts 12 shown in the embodiment of FIG. 1 may be manufactured with tabs (not shown) that cover one or more of the sensor mounts 12. The tabs can be removed when the housing is configured to accommodate a sensor. In this respect, housings can be configured with a desired number and type of sensors without joining housing segments together. Breakaway or breakout tabs may also be used with housing segments that are joined together, such as to selectively cover wire ports used to pass wires between individual housing segments.

Sensor housings may also include a communication interface 16, as shown in the embodiment of FIG. 1. The communication interface 16 provides a connection point to the building management system 18, through which data may be exchanged via a wired or wireless communication link. Data may include sensor output from the device 11, instructions to or from sensor processor(s) 14, instructions for any actuators of the device 11, lighting instructions for the device 11 (e.g., in cases where the device 11 is a light fixture, for instance), and/or other types of information. Power may additionally be provided to the device 11 through the communication interface 16, according to some embodiments. A standard lighting system communication interface such as Digital Addressable Lighting Interface protocol (DALI), Digital Multiplex packet based protocol (DMX), or a proprietary protocol may be used to interface the sensor block of device 11 with the building management system 18. According to some embodiments, the communication interface 16 and any processor(s) of the housing 10 may be configured to a common standard, such that interaction between the sensors (e.g., 22, 26, 28, 30, and 32) and the building management system 18 may utilize a common communication protocol or language.

The user interface 20 may allow a user to receive information directly from the multi-condition sensing device, according to some embodiments. Information may include output relating to environmental conditions, such as temperature at the sensor, various temperatures in the field of view of the IR array 26 (e.g., maximum, minimum, average temperatures), humidity, time, and the like. Operational information may, additionally or alternatively, be communicated through the user interface 20. Such information may include operational set points, such as thermostat settings, operational modes, such as whether a smoke detector is in an operating mode, and other setting information.

The user interface 20 may be built into to device and/or may include a communication port over which a user may interface with the device. According to some embodiments, the user interface 20 includes a display having a readout that may be viewed by a user. Ports over which a user may communication with the device may include wired connections or wireless connections. Wireless connections may utilize near field communications, including but not limited to those defined by IEEE 802.11, BLUETOOH, and the like. User interfaces may also allow a user to interface with the device through a separate computer, such as a desktop, laptop, or mobile computing device. The user interface may be passive, merely providing sensor and/or system information to a user. Alternately, the user interface 20 may receive input from a user, such as thermostat set points and schedules.

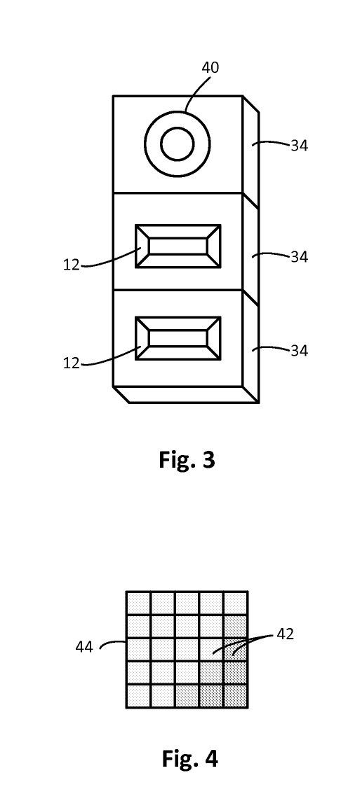

Multi-condition sensing devices may also include actuators that interact with the building environment in efforts to control environmental conditions. By way of example, FIG. 3 shows a housing segment that includes a lighting element 40. As with the embodiment of FIG. 2, sensors may be engaged with the lighting element to provide a common housing for multiple devices. In a more general sense, FIG. 3 can be viewed as showing a lighting fixture having the sensor(s) and lighting element(s) 40 contained therein in a common housing or multiple housings operatively coupled to one another. The lighting fixture may be, for example, an LED-based luminaire or light engine, although any other suitable lighting fixtures can equally benefit from the techniques provided herein. In one example embodiment, the sensors may include an IR array and/or any other type of sensor. It is additionally to be appreciated that a lighting element 40 may be incorporated into a housing that includes mounts for other sensors. A light element for illuminating a given environment during normal occupancy conditions is but one type of actuator that may be incorporated into a multi-condition sensing device. Other types of actuators include, but are not limited to flashing lights and/or sirens that may be used to alert occupants of an unwanted fire or other detected hazards indicative of abnormal conditions.

Sensors of a device 11 may provide environmental information to a building management system 18, as shown in FIG. 1, that provides overall supervisory and control functions for the building. Actuators of the device 11 or other devices may be actuated, by the building management system 18, in efforts to control conditions within environments of a building. Control functions that may be implemented through the building management system 18 are diverse, and may include activities that relate to activating, controlling, scheduling, troubleshooting, reporting, logging, detecting, and/or alarming actuators and/or sensors to manage the environment of a building, as may be prescribed by a building manager or other entity.

An IR array 26 may be used to detect environmental condition, such as unwanted fire, through various techniques. An IR array detects an IR signature produced by objects emitting IR radiation, as associated with heat, within a corresponding environment of the building. The IR signature is a spatial and/or temporal map of IR emissions or heat levels, as witnessed by the IR array. FIG. 4 shows one example of an IR signature 42 as witnessed by an IR array having a 5×5 grid 44 of pixels at a particular time.

IR signatures may be assessed by the processor 14 and/or building management system 18 (or some other entity) to detect undesirable or unwanted conditions within the given environment. Such assessments may be made by automatically reviewing portions of IR radiation detected within the field of an IR array for an IR signature that may be associated with unwanted fire. IR signatures may be identified spatially, by identifying particular spatial patterns among IR radiation/temperature distributions within the field of an IR array. Additionally or alternately, the change over time of values associated with individual pixels or groupings of pixels may be assessed by the building management system to identify IR signature associated with various environmental conditions.

IR signatures afford a building management system and/or sensor processor an improved ability to accurately detect unwanted environmental conditions. One manner in which this occurs is by minimizing false positive indications of unwanted fire. Conventional techniques for detecting unwanted fire rely on detection of smoke, which may alternately be present due to activities that are not unwanted, such as cooking Determining the presence of an unwanted condition in the environment through assessment of IR signatures affords the building management system and/or processor a greater ability to make an accurate assessment.

Software may be provided with an IR array that defines standard characteristics of an unwanted condition in an environment. Such characteristics may include unusual high temperatures at particular points within an environment (e.g., greater than 400 degrees Celsius), repetitive high temperature gradients indicative of wiggling flames in front of a cooler background, and/or large areas of unusually elevated temperatures (e.g., more than 150 degrees Celsius), among other conditions.

Sensors and/or building management systems may adapt to identify IR signatures that are not associated with unwanted conditions, improving detection accuracy. By way of example, an IR array, after being installed, may detect high temperatures associated with the sunrise as viewed through windows within an environment. The system may be programmed to identify such an occurrence as being not unwanted. This may occur automatically through logic within the building management system that identifies reoccurring patterns. This may, additionally or alternately, occur by a user programming the building management system and/or processor by identifying IR signatures associated with conditions that are not unwanted. This may be particularly useful for conditions that produce IR signatures that include features of those that may be similar to those associated with unwanted conditions, such as a cooking/baking conditions and conditions where a desired fire is lit within a fireplace.

Additional sensors, as may be incorporated into a housing of a multi-condition sensor, may provide data to a building management system that may aid in determining whether an IR signature represents an unwanted condition. A temperature sensor may help determine the temperature level or act to confirm temperature data received from an IR array. Humidity information, received from a humidity sensor, may provide an additional data point used by the building management system to determine whether an unwanted condition is present, such as unwanted fire.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

The above-described embodiments of the present invention can be implemented in any of numerous ways. For example, the embodiments may be implemented using hardware, software or a combination thereof. When implemented in software, the software code may be executed on any suitable processor or collection of processors, whether provided in a single computer or distributed among multiple computers.

According to one embodiment, a multi-condition sensing device is disclosed. The device includes a housing including a plurality of sensor mounts. The device also comprises a plurality of sensors, including an IR array mounted to a first of the sensor mounts of the housing, and adapted to sense IR radiation within a first environment of the building. A second sensor of the plurality of sensors is mounted to a second of the sensor mounts of the housing and is adapted to sense a second environmental condition, different than the IR radiation, within the first environment of the building. According to one such example, a lighting element is mounted to the housing and is adapted to illuminate at least a portion of the first environment of the building. According to another example, the plurality of sensors includes a third sensor mounted to a third of the sensor mounts of the housing and adapted to sense a third environmental condition, different than the IR radiation and different than the second environmental condition, within the first environment of the building. The plurality of sensors are removably mountable to the housing with the one or more of the plurality of sensors associated with a plug and play sensor card, according to one example. The multi-condition sensing device according may optionally include a processor associated with the IR array and one or more of the plurality of sensors. In one example, the device includes a communication interface that facilitates communication between a building management system and each of the plurality of sensors, wherein a common communication protocol is used for communicating between the building management system and each of the plurality of sensors. According to another example, the housing includes a plurality of joinable segments, each of the plurality of joinable segments including at least one of the sensor mounts. In another example case, the device may be combined with a building management system. The building management system may include at least one processor and at least one computer readable storage medium having encoded thereon executable instructions that, when executed by the at least one processor, cause the at least one processor to carry out a method that includes sensing unwanted fire conditions. Sensing the unwanted fire conditions of the first environment includes identifying an IR signature associated with an unwanted fire, according to one example. The IR signature associated with the unwanted fire includes temperature within the environment exceeding about 400 degrees Celsius at least at one point, repetitive high temperature gradients, or large areas of temperatures greater than about 150 degrees Celsius, according to various examples. According to another example, the device includes at least one processor and at least one computer readable storage medium having encoded thereon executable instructions that, when executed by the at least one processor, cause the at least one processor to carry out a method that includes sensing unwanted fire conditions.

According to another embodiment, a multi-condition sensing system includes an IR sensor adapted to sense IR radiation within an environment and an image analysis processor configured to receive sensor data from the IR sensor and to determine if there is occupancy of the environment and if there is unwanted fire in the environment, based on the sensor data. In one such example configuration, a lighting fixture having one or more lighting elements that at least one of turn on and turn off in response to changes in occupancy detected by the IR sensor is included with the system. The image analysis processor may be local to the IR sensor, or remote from the IR sensor. In some example cases, the system further includes a transmitter configured to communicate the sensor data from the IR sensor to the image analysis processor. Numerous variations and configurations will be apparent in light of this disclosure. For instance, another example embodiment provides a luminaire that includes a system as variously defined in this paragraph.

According to another embodiment, a lighting assembly comprises a lighting element, an IR sensor adapted to sense IR radiation within an environment, and an image analysis processor configured to determine if there is occupancy (e.g., human occupancy) of the environment and if there is unwanted fire in the environment, based on sensor data from the IR sensor. In one example, the lighting assembly further includes a transmitter configured to send or otherwise communicate at least one of sensor data from the IR sensor and determinations from the processor. Another example embodiment provides a luminaire that includes a lighting assembly as variously defined in this paragraph.

It should be appreciated that a computer may be embodied in any of numerous forms, such as a rack-mounted computer, a desktop computer, a laptop computer, or a tablet computer. Additionally, a computer may be embodied in any device with suitable processing capabilities, including a mobile electronic device, a smart phone or any other suitable portable or fixed electronic device.

Also, a computer may have one or more input and output devices. These devices may be used, among other things, to present a user interface. Examples of output devices that may be used to provide a user interface include printers or display screens for visual presentation of output, and speakers or other sound generating devices for audible presentation of output. Examples of input devices that may be used for a user interface include keyboards, microphones, and pointing devices, such as mice, touch pads, and digitizing tablets.

Such computers may be interconnected by one or more networks in any suitable form, including a local area network (LAN) or a wide area network (WAN), such as an enterprise network, an intelligent network (IN) or the Internet. Such networks may be based on any suitable technology and may operate according to any suitable protocol and may include wireless networks, wired networks, and/or fiber optic networks.

A computer system may be used in connection with any of the embodiments of the invention described herein. The computer system may be used as a building management system, as in the example embodiment of FIG. 1, and may include one or more processors and one or more non-transitory computer-readable storage media (e.g., memory and one or more non-volatile storage media). The processor may control writing data to and reading data from the memory and the non-volatile storage device in any suitable manner, as the aspects of the invention described herein are not limited in this respect. To perform any of the functionality described herein, the processor may execute one or more instructions stored in one or more computer-readable storage media (e.g., the memory), which may serve as non-transitory computer-readable storage media storing instructions for execution by the processor.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework. In this respect, various inventive concepts may be embodied as at least one non-transitory computer readable storage medium (e.g., a computer memory, one or more magnetic discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that performs particular tasks or implement particular abstract data types. Typically the functionality of the program modules may be combined or distributed as desired in various embodiments.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law. Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A multi-condition sensing device, comprising:
a housing including a plurality of sensor mounts;
a plurality of sensors, including an IR array mounted to a first of the sensor mounts of the housing, and adapted to sense IR radiation within a first environment of the building; and
a second sensor of the plurality of sensors mounted to a second of the sensor mounts of the housing and adapted to sense a second environmental condition, different than the IR radiation, within the first environment of the building.

2. The multi-condition sensing device according to claim 1, further comprising:
a lighting element mounted to the housing and adapted to illuminate at least a portion of the first environment of the building.

3. The multi-condition sensing device according to claim 1, wherein the plurality of sensors includes a third sensor mounted to a third of the sensor mounts of the housing and adapted to sense a third environmental condition, different than the IR radiation and different than the second environmental condition, within the first environment of the building.

4. The multi-condition sensing device according to claim 1, wherein one or more of the plurality of sensors are removably mountable to the housing, the one or more of the plurality of sensors associated with a plug and play sensor card.

5. The multi-condition sensing device according to claim 1, further comprising:
a processor associated with the IR array and one or more of the plurality of sensors.

6. The multi-condition sensing device according to claim 1, further comprising:
a communication interface that facilitates communication between a building management system and each of the plurality of sensors, wherein a common communication protocol is used for communicating between the building management system and each of the plurality of sensors.

7. The multi-condition sensing device according to claim 1, wherein the housing includes a plurality of joinable segments, each of the plurality of joinable segments including at least one of the sensor mounts.

8. The multi-condition sensing device according to claim 1, in combination with a building management system and wherein the building management system includes at least one processor and at least one computer readable storage medium having encoded thereon executable instructions that, when executed by the at least one processor, cause the at least one processor to carry out a method that includes sensing unwanted fire conditions.

9. The multi-condition sensing device according to claim 8, wherein sensing the unwanted fire conditions of the first environment includes identifying an IR signature associated with an unwanted fire.

10. The multi-condition sensing device according to claim 9, wherein the IR signature associated with the unwanted fire includes temperature within the environment exceeding about 400 degrees Celsius at least at one point.

11. The multi-condition sensing device according to claim 9, wherein the IR signature associated with the unwanted fire includes repetitive high temperature gradients.

12. The multi-condition sensing device according to claim 9, wherein the IR signature associated with the unwanted fire includes large areas of temperatures greater than about 150 degrees Celsius.

13. The multi-condition sensing device according to claim 1, further comprising:
at least one processor and at least one computer readable storage medium having encoded thereon executable instructions that, when executed by the at least one processor, cause the at least one processor to carry out a method that includes sensing unwanted fire conditions

14. A multi-condition sensing system, comprising:
an IR sensor adapted to sense IR radiation within an environment; and
an image analysis processor configured to receive sensor data from the IR sensor and to determine if there is occupancy of the environment and if there is unwanted fire in the environment, based on the sensor data.

15. The system of claim 14, further comprising:
a lighting fixture having one or more lighting elements that at least one of turn on and turn off in response to changes in occupancy detected by the IR sensor.

16. The system of claim 14, wherein the image analysis processor is remote from the IR sensor.

17. The system of claim 16, further comprising:
a transmitter to communicate the sensor data from the IR sensor to the image analysis processor.

18. A luminaire comprising the system of claim 14.

19. A lighting assembly, comprising:
a lighting element;
an IR sensor adapted to sense IR radiation within an environment; and
an image analysis processor configured to determine if there is occupancy of the environment and if there is unwanted fire in the environment, based on sensor data from the IR sensor.

20. The assembly of claim 16, further comprising:
a transmitter to communicate at least one of sensor data from the IR sensor and determinations from the processor.

21. A luminaire comprising the assembly of claim 19.
